(19) United States
(12) Patent Application Publication
(10) Pub. No.: US 2025/0344021 A1
(43) Pub. Date: Nov. 6, 2025

(54) METHODS AND APPARATUS TO MITIGATE NONLINEARITY IN LOW-POWER SPEAKER DEVICES

(71) Applicant: Texas Instruments Incorporated, Dallas, TX (US)

(72) Inventors: Srinivas K, Anantapur (IN); Vallabha Vasant Hampiholi, Bangalore (IN)

(21) Appl. No.: 18/821,688

(22) Filed: Aug. 30, 2024

(30) Foreign Application Priority Data
May 6, 2024 (IN) 202441035706

(51) Int. Cl. H04R 3/04

(52) U.S. Cl. CPC H04R 3/04

(57) ABSTRACT

An example apparatus includes: equalizer circuitry having first and second inputs and an output, the equalizer circuitry configured to adjust an audio signal at the first input responsive to coefficient values at the second input; amplifier circuitry having an input coupled to the output of the equalizer circuitry, and having an output; control circuitry having a first input coupled to the first input of the equalizer circuitry, having a second input coupled to the output of the amplifier circuitry, and having an output coupled to the second input of the equalizer circuitry, the control circuitry configured to determine a resonant frequency of a speaker device responsive to the audio signal and a signal at the output of the amplifier circuitry, and to provide the coefficient values at the output of the control circuitry responsive to the resonant frequency of the speaker.

### RELATED APPLICATION

This patent claims the benefit of Indian Provisional Patent Application No. 202441035706, which was filed on May 6, 2024. Indian Provisional Patent Application No. 202441035706 is hereby incorporated herein by reference in its entirety. Priority to of Indian Provisional Patent Application No. 202441035706 is hereby claimed.

### TECHNICAL FIELD

This description relates generally to audio and, more particularly, to methods and apparatus to mitigate nonlinearity in low-power speaker devices.

### BACKGROUND

Amplifiers are used to amplify signals, such as audio signals. Because amplifiers may transmit analog or digital audio signals, amplifiers with low harmonic distortion and stable excursion profiles are desirable to provide the best audio sound qualities. The harmonic distortion and excursion profile of a speaker are responsive to the nonlinearity of the speaker. In turn, the amount of nonlinearity of a speaker is responsive to the mechanical structures within and around the speaker.

### SUMMARY

For methods and apparatus to mitigate nonlinearity in low-power speaker devices, a first example apparatus includes: equalizer circuitry having first and second inputs and an output, the equalizer circuitry configured to adjust an audio signal at the first input responsive to coefficient values at the second input; amplifier circuitry having an input coupled to the output of the equalizer circuitry, and having an output; control circuitry having a first input coupled to the first input of the equalizer circuitry, having a second input coupled to the output of the amplifier circuitry, and having an output coupled to the second input of the equalizer circuitry, the control circuitry configured to determine a resonant frequency of a speaker device responsive to the audio signal and a signal at the output of the amplifier circuitry, and to provide the coefficient values at the output of the control circuitry responsive to the resonant frequency of the speaker device.

A second example apparatus includes comprising: control circuitry configured to: determine a speaker device resonant frequency; and determine coefficient values responsive to the speaker device resonant frequency and a speaker device nonlinear model; equalizer circuitry coupled to the control circuitry and configured to provide an adjusted audio signal using the coefficient values; and amplifier circuitry coupled to the equalizer circuitry and configured to amplify the equalized audio signal to provide an output audio signal.

A third example apparatus comprises control circuitry configured to: measure membrane excursion values of a speaker device at different frequencies to determine a maximum excursion value; determine maximum voltages that correspond at different frequencies to the maximum excursion value; and determine, responsive to the maximum voltages, a nonlinear model corresponding to the speaker device.

### BRIEF DESCRIPTION OF THE DRAWINGS

FIG. 1 is a block diagram of an example environment that includes modeling circuitry and a mobile device.

FIG. 2 is a block diagram of an example of the audio amplifier circuitry of FIG. 1.

FIG. 3 is a block diagram of an example of the resonant frequency tracker circuitry of FIG. 2.

FIG. 4 is a block diagram of an example of the filter bank circuitry of FIG. 2.

FIG. 5 is a block diagram of an example of the coefficient calculator circuitry of FIG. 2.

FIG. 6 is a block diagram of an example of the equalizer circuitry of FIG. 2.

FIG. 7 is a flowchart representative of example machine-readable instructions or example operations that may be at least one of executed, instantiated, or performed using an example programmable circuitry implementation of the audio amplifier circuitry of FIG. 1.

FIGS. 8A and 8B are first example graphs comparing the performance of the audio amplifier circuitry of FIG. 1 to other audio amplifiers.

FIGS. 9A, 9B, and 9C are second example graphs comparing the performance of the audio amplifier circuitry of FIG. 1 to other audio amplifiers.

FIG. 10 is a block diagram of an example of the modeling circuitry of FIG. 1.

FIG. 11A is an example graph illustrating speaker profile data of the mobile device of FIG. 1.

FIG. 11B is an example graph showing expected speaker excursion of the low-profile speaker of FIG. 1.

FIG. 11C is an example graph showing the actual speaker excursion of the low-profile speaker of FIG. 1.

FIG. 12 is an example graph showing the nonlinear model of FIG. 1.

FIG. 13 is a flowchart representative of example machine-readable instructions or example operations that may be at least one of executed, instantiated, or performed using an example programmable circuitry implementation of the modeling circuitry of FIG. 1.

FIG. 14 is a block diagram of an example processing platform including programmable circuitry structured to execute, instantiate, or perform the example machine-readable instructions or perform the example operations of FIGS. 7 and 13 to implement the modeling circuitry 106 or audio amplifier circuitry 116B of FIG. 2 or 10.

FIG. 15 is a block diagram of an example of the programmable circuitry of FIG. 14.

FIG. 16 is a block diagram of another example of the programmable circuitry of FIG. 14.

FIG. 17 is a block diagram of an example software/firmware/instructions distribution platform (e.g., one or more servers) to distribute software, instructions, or firmware (e.g., corresponding to the example machine-readable instructions of FIGS. 7 and 13) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The drawings are not necessarily to scale. Generally, the same reference numbers in the drawing(s) and this description refer to the same or similar (functionally or structurally) features or parts. Although the drawings show regions with clean lines and boundaries, some or all of these lines and boundaries may be idealized. In reality, the boundaries or lines may be unobservable, blended or irregular.

### DETAILED DESCRIPTION

As used above and herein, speaker device nonlinearity refers to a nonlinear relationship between two related phenomena within the speaker device. Examples of speaker nonlinearities include but are not limited to: a nonlinear relationship between the stiffness of a speaker suspension and the force required to return the suspension to equilibrium; a nonlinear relationship between the voltage applied to a speaker membrane and the distance the membrane moves; a nonlinear relationship between sound pressure inside the speaker box and airflow; a nonlinear relationship between the stress and the strain of the speaker cone, etc. Designers and manufacturers of speaker devices seek to reduce or mitigate nonlinearities because they can decrease the performance and degrade the structure of the device. Furthermore, designing and implementing effective countermeasures to nonlinearities can add cost and complexity to a device.

One manner through which speaker nonlinearities decrease performance is through degradation of audio quality. In general, nonlinearities give rise to more audio distortion as the amplitude of the audio signal increases and the frequency of the audio signal decreases. Therefore, audio signals set at a relatively high volume (e.g., a large amplitude) and including a relatively large amount of energy in the bass frequencies (e.g., low frequency ranges) experience more distortion at a speaker device than audio signals set at a relatively low volume (e.g., a smaller amplitude) and including a relatively small amount of energy in the bass frequencies. As used above and herein, the terms “amplitude,” “magnitude,” and “voltage” of the audio signal may be used interchangeably.

Some speaker devices attempt to mitigate the effects of audio distortion by applying a high pass filter to remove the bass frequencies from an audio signal. However, many use cases (e.g., music) include audio signals that intentionally have large amounts of energy in bass frequencies. Accordingly, removing bass frequencies to remove distortion still reduces audio quality because the filtering fundamentally changes the desired sound of the signal. Moreover, removing bass frequencies does not address audio distortions that are responsive to large signal amplitudes and that are not in the bass region.

Another manner through which speaker nonlinearities decrease performance is through mechanical degradation. A speaker is designed to generate sound by vibrating a membrane back and forth around a set “zero” position. In some examples, the speaker membrane is referred to as a diaphragm. The speaker is also designed with a maximum excursion value, which refers to the distance the membrane moves away from the zero position while vibrating. In general, a speaker device can meet its expected product life span if the membrane does not vibrate past the maximum excursion value. However, in some examples, due to nonlinearities the membrane vibrates farther than the extent to which the speaker device was specified and, thus, exceeds the maximum excursion value. Accordingly, the mechanical attributes of the speaker degrade over time due to the nonlinearities.

A DC offset refers to a condition in which, due to mechanical stresses from the speaker membrane repeatedly exceeding the maximum excursion value, the drive system within the speaker device loses control of the moving mass that causes vibration. Thus, the membrane of the speaker no longer vibrates around the zero position. Instead, the vibrations of the speaker are centered at some other position that is offset from the zero position. The DC offset further degrades the structure of the speaker device because the speaker may routinely exceed its specified maximum excursion, which decreases product life span.

Some high-power speaker devices (e.g., a speaker that is rated to use ten or more Watts) reduce DC offset by implementing a predistortion filter to change the shape of the audio signal before it is played at the high-power speaker device. The predistortion filter is responsive to a model of the speaker device that predicts the amount the speaker membrane moves at various frequencies. In high-power speaker devices, model predictions generally corelate well with the actual membrane movement measured at the speaker. However, the amount of nonlinear behavior exhibited by a speaker is highly dependent on the mechanical structure and surrounding environment of the speaker. As used above and herein, the terms “speaker device” and “speaker” may be used interchangeably.

As used above and herein, a low-power speaker device includes but is not limited to speaker devices that are rated to use three Watts of power or less. There are several differences in the mechanical structure between high-power speaker devices and low-power speaker devices. For example, high-power speakers generally encompass a larger volume (e.g., three-dimensional space) than low-power speaker devices. The larger volume can support larger speaker components, e.g., magnets, voice coils, etc. Whereas, low-power speaker devices encompass a smaller volume and therefore have smaller components. In some examples, low-power speaker devices implement different architectures with different types of components than high-power speakers due to the difference in three-dimensional space. High-power speakers also support membranes that vibrate further distances than small-membrane speakers. Furthermore, high-power speakers generally have separate assemblies for their spider and suspension components, whereas similar components in low-power speaker devices are generally glued to the voice coil.

High-power and low-power speakers also have different surrounding environments. High-power speaker devices may be implemented in vehicles, radios, as standalone devices for concert venues, etc. As a result, high-power speaker devices generally have speaker grills that directly face open air. Low-power speaker devices, in contrast, may be implemented as an internal component within a mobile computing device, e.g., a smartphone, a tablet, a laptop, etc. As a result, sound generated by a low-power speaker device generally travels through a port before reaching open air, reflecting off other components of the mobile device along the way.

Low-power speaker devices generally exhibit more nonlinear behavior than high-power speaker devices due to the foregoing mechanical and environmental differences. The differences also result in designers implementing high-power speaker devices with transistors that generally have more headroom voltage and greater flexibility to pre-distort the audio signal than low-power devices. As a result, the technique used to model membrane excursion in high-power speakers cannot be used to accurately model membrane excursion in low-power speaker devices. Thus, the foregoing pre-distortion filter does not improve performance in low-power speaker devices.

Example methods, apparatus, and systems described herein reduce the effects of speaker device nonlinearity and enhance bass frequencies in low-power speaker devices. Example modeling circuitry creates a speaker device nonlinear model by measuring actual membrane excursion values when the speaker is implemented a particular environment, e.g., within a particular model of a mobile device. Within a separate instance of the same mobile device, example audio amplifier circuitry stores the coefficients that form the speaker device nonlinear model in memory. The audio amplifier circuitry also includes example resonant frequency tracker which determines the resonant frequency, for instance in substantially real time, of the low-power speaker device responsive to example current sense circuitry and example voltage sense circuitry. Example coefficient calculator circuitry then uses the speaker device nonlinear model and a version of an input signal centered at the current speaker device resonant frequency to determine equalization coefficients. Example equalizer circuitry uses the equalization coefficients to shape the audio signal so that, after the signal is amplified and provided to the low-speaker device, the amplitude of the bass frequency is increased, the membrane vibration stays centered at the intended zero position, and the movement of the membrane stays at or under the maximum excursion value at all frequencies.

As used above and herein “substantially real time” refers to the processing of an input signal that occurs in a near immediate manner recognizing there may be real world delays for computing time, transmission, etc. Thus, unless otherwise specified, “substantially real time” refers to immediate signal processing+1 second.

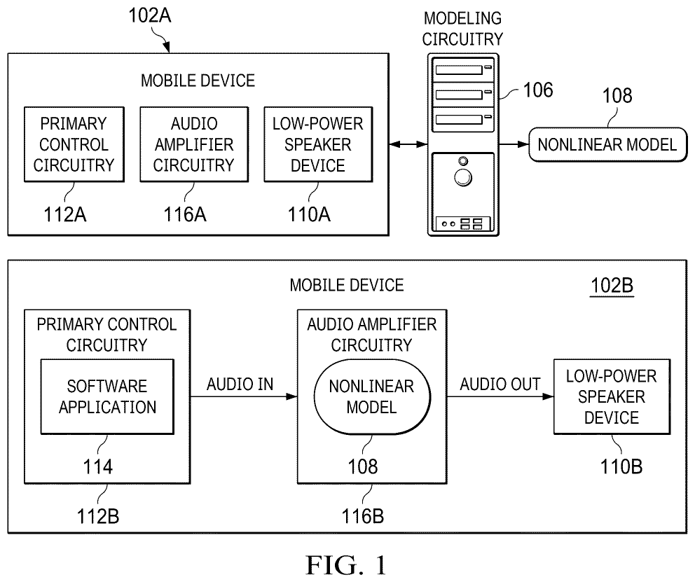

FIG. 1 is a block diagram of an example environment that includes modeling circuitry and a mobile device. FIG. 1 includes example mobile devices 102A and 102B, example modeling circuitry 106, and an example nonlinear model 108. The mobile device 102A includes example primary control circuitry 112A, example audio amplifier circuitry 116A, and an example low-power speaker device 110A. Similarly, the mobile device 102B includes example primary control circuitry 112B that implements an example software application 114, example audio amplifier circuitry 116B that stores the nonlinear model 108, and an example low-power speaker device 110B.

In examples described herein, the mobile device 102A and 102B are two different instances of the same product. Accordingly, both mobile devices 102 have the same physical components, dimensions, weight, and mechanical structure.

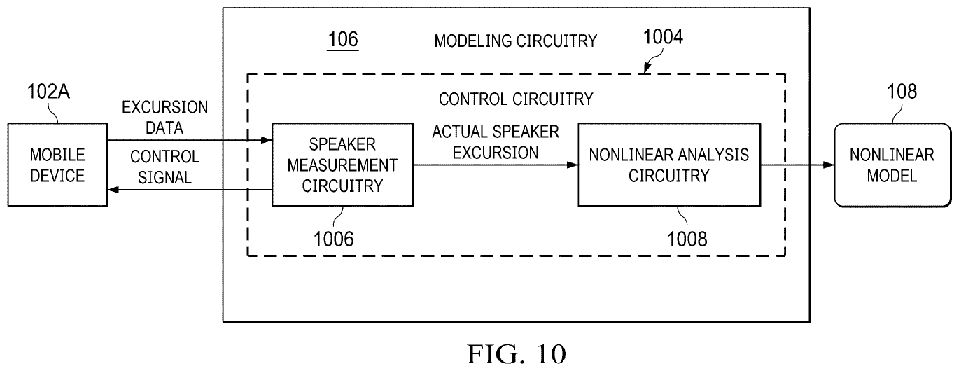

The mobile device 102A may be a preliminary version of the device that is not available to the general public. Accordingly, the audio amplifier circuitry 116A does not store a copy of the nonlinear model 108. Rather, the modeling circuitry 106 generates the nonlinear model 108 by measuring at least one of parameters, signals, or values provided by, related to, or representative of components of the mobile device 102A. As used above and herein, the nonlinear model 108 refers to data that represents how the expected performance of the low-power speaker devices 110 differs from its actual performance due to nonlinearities. The modeling circuitry 106 is described further in connection with FIG. 10. In some examples, the nonlinear model 108 is referred to as a speaker device nonlinear model.

In contrast to the mobile device 102A, the mobile device 102B may be a finished product available to consumers for purchase. The primary control circuitry 112B coordinates the operations of the other components within the mobile device 102B. For example, the primary control circuitry 112B executes an operating system, determines which visuals are presented on a display, instructs camera circuitry within the mobile device to take a picture, instructs interface circuitry within the mobile device to exchange data over a network, etc. The primary control circuitry 112B may be implemented using any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The mobile device 102B also executes the software application 114. The software application 114 refers to any type of machine-readable instructions or operations that, when executed by the primary control circuitry 112B, generate an audio signal. The audio signal may be any type of audio, including but not limited to music, podcasts, video, etc.

The audio amplifier circuitry 116B receives the audio signal from the software application 114. The audio amplifier circuitry 116B then uses a copy of the nonlinear model 108, which was programmed into the audio amplifier circuitry 116B during the manufacture of the mobile device 102B, to adjust one or more properties of the audio signal. The audio amplifier circuitry 116B provides the adjusted audio signal to the low-power speaker device 110B. In turn, the membrane of the low-power speaker device 110B vibrates responsive to the adjusted audio signal to produce sound.

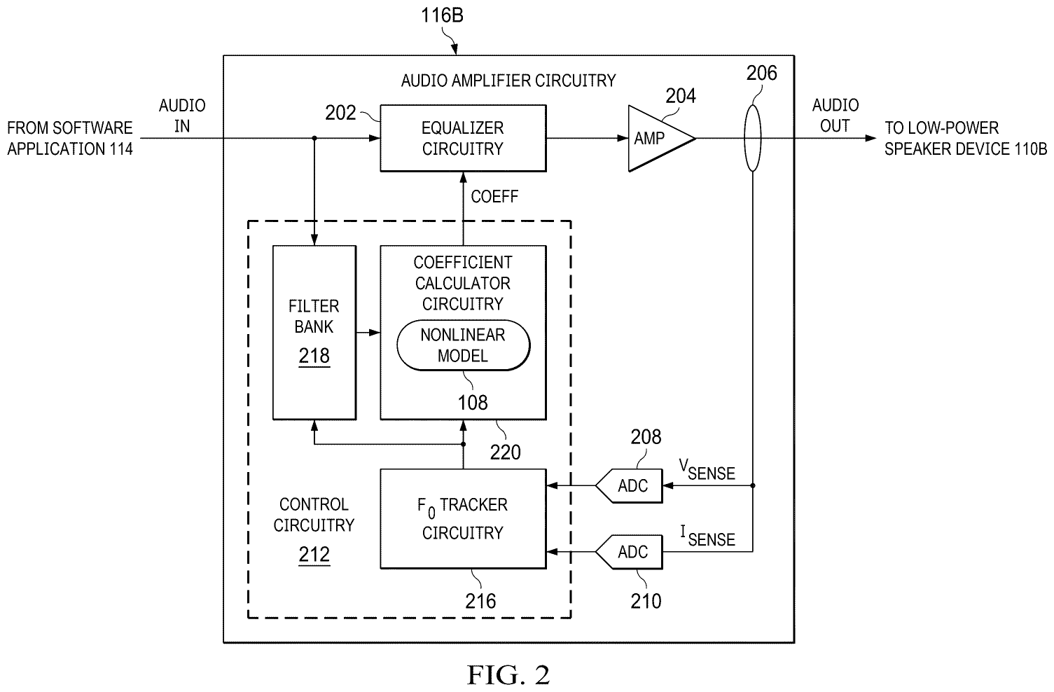

In some examples, the audio amplifier circuitry 116B is implemented on a stand-alone integrated circuit (IC). In other examples, the audio amplifier circuitry 116B is implemented as part of a System on a Chip (SoC) with other components. The audio amplifier circuitry 116B is described further in connection with FIG. 2.

Notably, the nonlinear model 108 enables the audio amplifier circuitry 116B to adjust the signal in a manner that: a) enhances the bass frequencies and b) keeps the membrane movement under the maximum excursion value across all frequencies. Accordingly, the mobile devices 102B exhibits fewer nonlinear behaviors, produces higher quality audio, and is more mechanically durable than mobile devices that incorporate other low-power speaker devices.

FIG. 2 is a block diagram of an example of the audio amplifier circuitry 116B of FIG. 1. The audio amplifier circuitry 116B includes example equalizer circuitry 202, example amplifier circuitry 204, example measurement circuitry 206, example ADC circuitry 208 and 210, and example control circuitry 212. The control circuitry 212 includes example resonant frequency (F₀) tracker circuitry 216, example filter bank circuitry 218, and example coefficient calculator circuitry 220. The coefficient calculator circuitry 220 stores the nonlinear model 108.

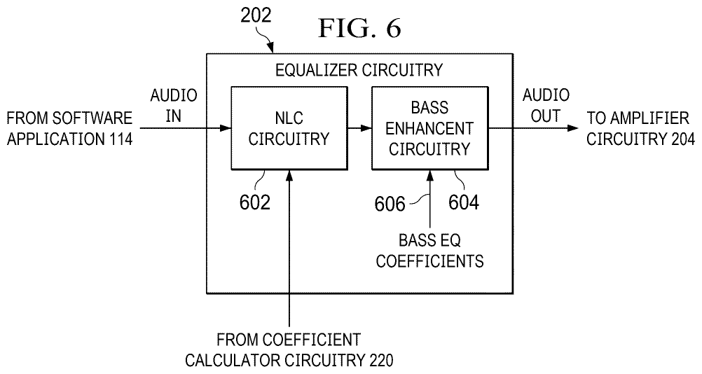

The equalizer circuitry 202 adjusts the input audio signal it receives from the software application 114, to for instance equalize the received audio signal. For example, to adjust the signal, the equalizer circuitry 202 applies a filter that attenuates low-frequency signal components, amplifies components up to the Nyquist frequency, and reduces the magnitude of higher frequencies. In some examples, such adjustments are referred to as equalizing the signal. The equalizer circuitry 202 performs adjustment operations responsive to equalization (EQ) coefficients that are set by the control circuitry 212. The equalizer circuitry 202 is described further in connection with FIG. 6. In some examples, the equalizer circuitry 202 may be referred to as Continuous Time Linear Equalization (CTLE) circuitry.

The equalizer circuitry 202 includes an output that is coupled to an input of the amplifier circuitry 204. The amplifier circuitry 204 amplifies the equalized signal by increasing the amplitude of the signal. The ratio between the signal amplitude at the output of the amplifier circuitry 204 and the signal amplitude at the input of the amplifier circuitry 204 is referred to as the gain of the amplifier circuitry 204. In some examples, the amplifier circuitry 204 may support any gain within a continuous range of values (or within a group of discrete values). In such examples, the specific gain value used by the amplifier circuitry 204 may be selected by the control circuitry 212 or an external component of the audio amplifier circuitry 116B.

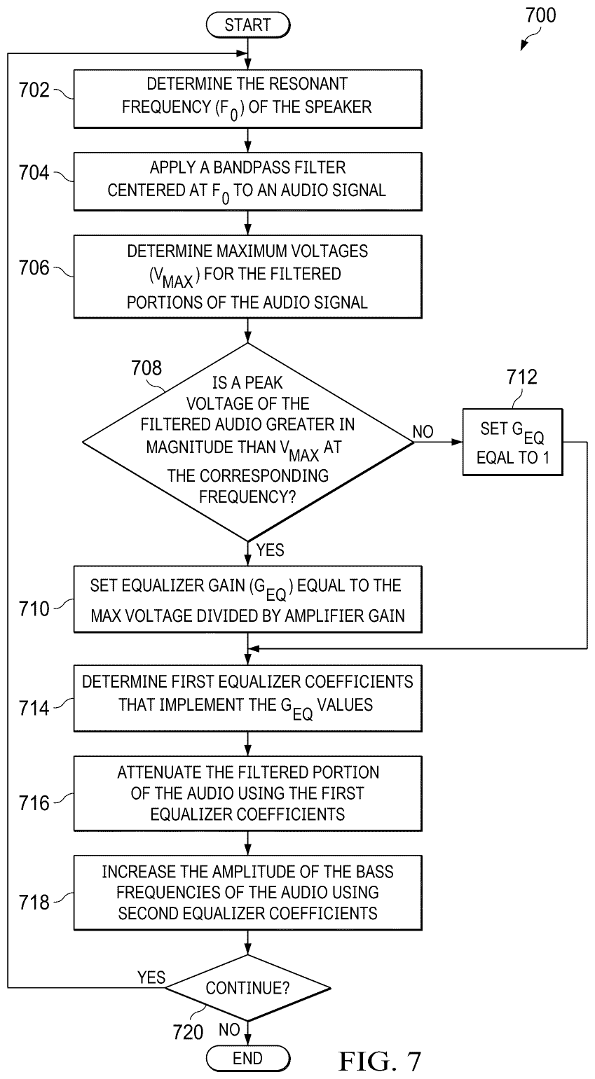

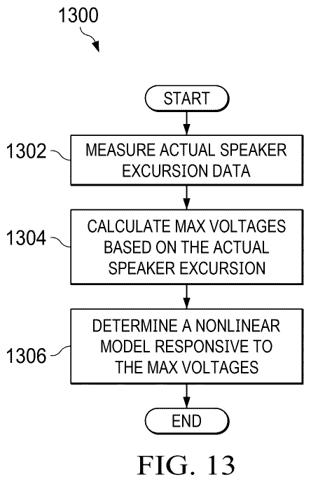

The amplifier circuitry 204 includes an output that is coupled to the low-power speaker device 110B, thereby enabling the low-power speaker device 110B to generate sound responsive to the amplified version of the adjusted audio signal. The output of the amplifier circuitry is also coupled to measurement circuitry 206. In an example, the measurement circuitry 204 generates both a VSENSE signal that represents the voltage of the output audio signal and an I_{SENSE} signal that represents the current of the audio going signal. In other examples, the measurement circuitry 206 generates either the V_{SENSE} signal or the I_{SENSE} signal. The measurement circuitry 204 may include any suitable components and use any suitable technique to generate the V_{SENSE} signal and I_{SENSE} signals. In some examples, the measurement circuitry 204 is referred to as IV sense circuitry. In some examples, the control circuitry 212 is instantiated by programmable circuitry executing amplifier instructions to perform operations such as those represented by the flowchart(s) of FIGS. 7 and 13.

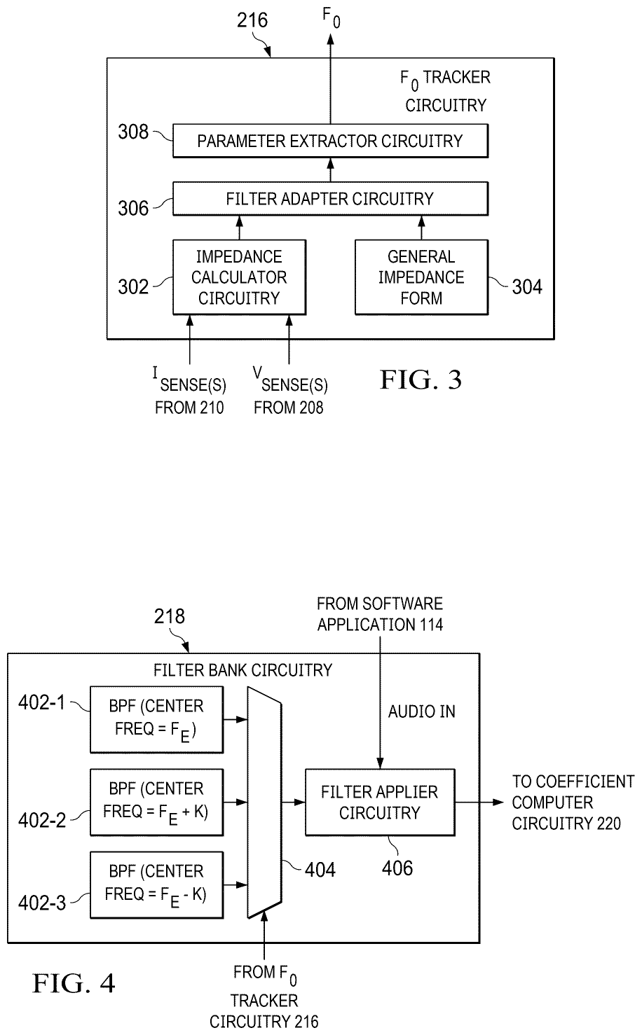

The ADC circuitry 208 and 210 convert the V_{SENSE} signal and I_{SENSE} signals, respectively, from analog signals to digital values. Both the incoming analog signals and outgoing digital values represent the voltage and current, respectively, of the output audio signal. In some examples, the digital values are referred to as V_{SENSE}(s) data and I_{SENSE}(s) data because, as described further in connection with FIG. 3, the voltage and current measurements change as a function of frequency.

Within the control circuitry 212, the F₀ tracker circuitry 216 determines the resonant frequency, for instance in substantially real time, of the low-power speaker device 110B responsive to the output audio signal. The value of the speaker device resonant frequency can change at any time due to any number of factors. Such factors include, but are not limited to, changes to the temperature of the surrounding environment as the low-power speaker device 110B generates sound or the mobile device 102B performs other operations, changes to the mass of the membrane as the membrane wears down or dust accumulates on it, etc. Tracking F₀ increases the accuracy of the audio amplifier circuitry 116B because the movement of the speaker membrane changes responsive to changes in the value of F₀. The F₀ tracker circuitry 216 is described further in connection with FIG. 3. In some examples, the F₀ tracker circuitry 216 is instantiated by programmable circuitry executing F₀ tracker instructions to perform operations such as those represented by the flowchart(s) of FIGS. 7 and 13.

The F₀ tracker circuitry 216 provides the speaker device resonant frequency, for instance in substantially real time, to the filter bank circuitry 218. The filter bank circuitry 218 filters a copy of the incoming audio signal to generate a version of the audio that is centered at the current resonant frequency. The filter bank circuitry 218 is described further in connection with FIG. 4. In some examples, the filter bank circuitry 218 is instantiated by programmable circuitry executing filter bank instructions to perform operations such as those represented by the flowchart(s) of FIGS. 7 and 13. As used above and herein, tracking a parameter, e.g., F₀, current, or voltage, refers to updating the parameter in substantially real time.

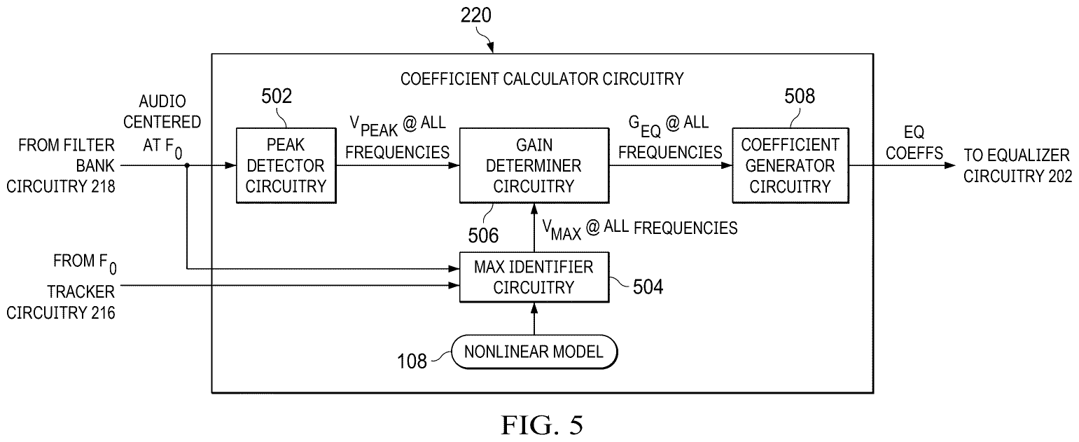

In this example, the coefficient calculator circuitry 220 uses: a) the centered version of the audio signal, b) the current resonant frequency value, and c) the nonlinear model 108, to generate equalization coefficients that account for the nonlinearities within the low-power speaker device 110. For example, the coefficient calculator circuitry 220 may generate coefficients that, when used by the equalizer circuitry 202, decrease the amplitude of the incoming audio at specific frequencies. If the low-power speaker device 110B were to play the audio signal adjusted using equalization coefficients from a different technique, the membrane would exceed the maximum excursion value at the specific frequencies. Such membrane movement would lead to DC offset and degradation of the product life span as described above. Instead, the low-power speaker device 110B plays audio adjusted using equalization coefficients from the control circuitry 212, and the membrane of the low-power speaker device 110B stays under the maximum excursion value at all frequencies. In other examples, the coefficient calculator circuitry 220 generates the equalization coefficients using one or a combination of two of: a) the centered version of the audio signal, b) the current resonant frequency value, and c) the nonlinear model 108. The coefficient calculator circuitry 220 is described further in connection with FIG. 5. In some examples, the coefficient calculator circuitry 220 is instantiated by programmable circuitry executing coefficient calculator instructions to perform operations such as those represented by the flowchart(s) of FIGS. 7 and 13.

In examples described herein, the control circuitry 212 is implemented as a Digital Signal Processor (DSP), a type of programmable circuitry that executes machine-readable instructions using the nonlinear model 108 and other data stored in memory. In other examples, the control circuitry 212 is implemented as a different type of programmable circuitry that uses logical hardware components instead of memory. In such other examples, the logical hardware of the audio amplifier circuitry is designed and implemented in a manner that still enables the control circuitry 212 to utilize the nonlinear model as described herein.

More generally, the control circuitry 212 of FIG. 2 may be instantiated (e.g., creating an instance of, bring into being for any length of time, materialize, implement, etc.) by programmable circuitry such as a Central Processor Unit (CPU) executing first instructions. Also or alternatively, the control circuitry of FIG. 2 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 2 may, thus, be instantiated at the same or different times. Some or all of the circuitry of FIG. 2 may be instantiated, for example, in one or more threads executing concurrently on hardware or in series on hardware. Moreover, in some examples, some or all of the circuitry of FIG. 2 may be implemented by microprocessor circuitry executing instructions or FPGA circuitry performing operations to implement one or more virtual machines or containers.

FIG. 3 is a block diagram of an example of the F₀ tracker circuitry 216 of FIG. 2. The F₀ tracker circuitry 216 includes example impedance calculator circuitry 302, an example general impedance form 304, example filter adapter circuitry 306, and example parameter extractor circuitry 308.

The impedance calculator circuitry 302 uses the V_{SENSE}(s) data provided by the ADC circuitry 208 and the I_{SENSE}(S) data provided by the ADC circuitry 210 to determine the substantially real time impedance (which is referred to herein as Z(s)) of the low-speaker device 110. To do so, the impedance calculator circuitry 302 implements equation 1:

$$Z ( s ) = \frac{{V}_{SENSE} ( s )}{{I}_{SENSE} ( s )} = {R}_{e} + {Z}_{BEMF} ( s ) \qquad ( 1 )$$

In equation (1), (s) refers to the complex frequency domain, Rₑ refers to the DC resistance of the voice coil of the low-power speaker device 110B, and Z_{BEMF}(S) refers to the impedance from back electromotive force (BEMF) that opposes a change in induced current. When the audio signal operates at a DC voltage with no frequency component, then Z_{BEMF}(s)=0 and the impedance of the speaker is equal to its resistance Re. When the audio signal instead has a nonzero frequency component, the value of Z_{BEMF}(s) changes responsive to the frequency. To account for this changing value of Z_{BEMF}(S), the general impedance form 304 enables the F₀ tracker circuitry 216 to model the substantially real time impedance as a second order system with a band pass filter. In particular, the general impedance form 304 refers to equations (2)-(6):

$$Z ( s ) = a + k ( \frac{s}{{s}^{2} + bs + c} ) \qquad ( 2 )$$

$$where$$

$$a = {R}_{e} \qquad ( 3 )$$

$$k = \frac{{( Bl )}^{2}}{{M}_{ms}} \qquad ( 4 )$$

$$b = \frac{{F}_{0}}{{Q}_{ms}} = \frac{{R}_{ms}}{{C}_{ms}} \qquad ( 5 )$$

$$c = {F}_{0}^{2} = \frac{1}{{C}_{ms} ( {M}_{ms} )} \qquad ( 6 )$$

As used above, Bl from equation (4) refers to the force factor of the low-power speaker device 110B, and Mₘₛ from equations (4) and (6) refers to the mechanical mass of the speaker. Furthermore, Qₘₛ from equation (5) refers to the mechanical attenuation of the speaker, Rₘₛ from equation (5) refers to the mechanical damping resistance of the speaker, and Cₘₛ from equations (5) and (6) refers to the mechanical compliance of the speaker. In some examples, the parameters in equations (2) through (6) are referred to as Thiele/Small parameters. The general impedance form 304 may also or alternatively be referred to as a template impedance form.

The filter adapter circuitry 306 applies a least mean square adaptive filter to compare the general impedance form 304 to the results of the impedance calculator circuitry 302. To do so, the filter adapter circuitry 306 estimates which values of k, b, and c from equations (4) through (6) best fit into equation (2), given that Rₑ is a constant and Z(s) is provided by the impedance calculator circuitry 302 using equation (1).

After the values of k, b, and c are determined, the parameter extractor circuitry 308 extracts the value of F₀ from one or more of equation (5) or (6). For example, the parameter extractor circuitry 308 can determine F₀ by taking the square root of c to solve equation (6).

Notably, the filter adapter circuitry 306 continuously re-solves equation (2) (or periodically re-solves equation (2) at regular intervals) to capture changes to the I_{SENSE}(s) and V_{SENSE}(s) data that may occur at any time. Accordingly, the F₀ tracker circuitry 216 continually tracks the resonant frequency of the low-power speaker device 110B as the value changes over time due to environmental conditions.

FIG. 4 is a block diagram of an example of the filter bank circuitry 218 of FIG. 2. The filter bank circuitry 218 includes example bandpass filters (BPFs) 402-1, 402-2, and 402-3 (collectively referred to as BPFs 402), an example multiplexer 404, and example filter applier circuitry 406.

The BPFs 402 refer to signals defined by a minimum frequency value, a maximum frequency value, and a center frequency value equidistant between the two. When one of the BPFs 402 is applied to an input signal, the amplitude of the input signal is reduced to zero (e.g., cut off) anywhere the frequency is outside the frequency band [minimum frequency, maximum frequency]. However, the input signal remains unchanged anywhere its frequency is within the foregoing band.

The frequency bands defined by the respective BPFs 402 are equal in length but are centered at different frequencies. In FIG. 4, the BPF 402-1 has a center frequency value of FE, which herein refers to an original estimation of the resonant frequency of the low-power speaker device 110B. The BPF 402-2 has a frequency value of (F_{E}+K) and the BPF 402-3 has a frequency value of (F_{E}−K), where

$$K = \frac{{F}_{E}}{2} .$$

As an example, 11 F_{E}=/20 Hz then K=350 Hz, BPF 402-1 is centered at 750 Hz, BPF 402-2 is centered at 1125 Hz, and BPF 402-3 is centered at 375 Hz.

In some examples, the filter bank circuitry 218 includes a different number or different type of filters than the three BPFs 402 shown in FIG. 4. Similarly, in some examples, the filter bank circuitry 218 implements a different value of K to offset the various filters from one another. In some examples, FE is programmed into the audio amplifier circuitry 116B during the design or manufacture of the mobile device 102B.

The multiplexer 404 includes one input for each of the BPFs 402. The multiplexer 404 also includes a control terminal coupled to the F₀ tracker circuitry 216 and an output coupled to the filter applier circuitry 406. The multiplexer 404 selects one of the BPFs 402 to pass to the filter applier circuitry 406. The multiplexer 404 performs the selection responsive to the determined speaker device resonant frequency provided at the control terminal. In particular, the multiplexer 404 selects the BPF whose center frequency is closest to the current value of F₀. Accordingly, the multiplexer 404 may select a different one of the BPFs 402 responsive to the changing value of F₀.

The filter applier circuitry 406 applies the selected BPF to the incoming audio signal it receives from the software application 114. Accordingly, the audio signal provided to the coefficient calculator circuitry 220 remains centered in the frequency domain at F₀ even as F₀ changes due to environmental conditions. The filter applier circuitry 406 may use any suitable technique (e.g., convolution) to apply the selected BPF to the incoming audio signal. The filter applier circuitry 406 applies a BPF so that the coefficient calculator circuitry 220 generates equalization coefficients that specifically mitigate nonlinearities around F₀ (as opposed to other frequencies). As described in connection with FIG. 6, the audio amplifier circuitry 116B uses a different set of equalization coefficients to mitigate nonlinearities corresponding to other frequencies.

FIG. 5 is a block diagram of an example of the coefficient calculator circuitry 220 of FIG. 2. The coefficient calculator circuitry 220 includes the nonlinear model 108, example peak detector circuitry 502, example max identifier circuitry 504, example gain determiner circuitry 506, and example coefficient generator circuitry 508.

The peak detector circuitry 502 receives the audio centered at F₀ from the filter bank circuitry 218. The peak detector circuitry 502 detects peaks within the filtered audio signal. As used above and herein, a peak in a signal refers to the voltage at a local maximum within the signal. The peak detector circuitry 502 detects the peak voltages at frequencies in the audio signal around F₀ (e.g., the frequencies passed along by the filter bank circuitry 218).

The max identifier circuitry 504 receives the audio centered at F₀ from the filter bank circuitry 218. The max identifier circuitry 504 also receives the value of F₀ from the F₀ tracker circuitry 216. The max identifier circuitry 504 applies the nonlinear model 108 to the audio signal to receive maximum voltages (which may be referred to herein as V_{MAX}). As used above and herein, V_{MAX} refers to a voltage that, when applied to the low-power speaker device 110B, leads to the membrane of the low-power speaker device 110B moving to the maximum excursion value. Because the relationship between voltage and membrane movement is a function of frequency, the max identifier circuitry 504 identifies different values of V_{MAX} for different frequencies within the audio signal.

The gain determiner circuitry 506 determines the gain of the equalizer circuitry 202 (which is herein referred to as G_{EQ}) across the frequencies around F₀. The relationship between V_{PEAK}, the peaks in the input audio voltage, and VOUT, the voltage in the out-going audio signal, is provided in equation (7):

$${V}_{OUT} = ( {V}_{PEAK} ) ( {G}_{EQ} ) ( {G}_{AMP} ) \qquad ( 7 )$$

In equation (7), G_{EQ} refers to the gain of the equalizer circuitry 202 and G_{AMP} refers to the gain of the amplifier circuitry 204. Notably, G_{EQ} changes responsive to the frequency of the audio signal, but G_{AMP} remains constant across all frequencies. Therefore, the gain determiner circuitry 506 determines different G_{EQ} values for different frequencies around F₀ using equations (8) and (9):

$${G}_{EQ} = 1 if {V}_{PEAK} ( {G}_{AMP} ) \leq {V}_{MAX} \qquad ( 8 )$$

$${G}_{EQ} = ( {V}_{MAX} / {G}_{AMP} ) if {V}_{PEAK} ( {G}_{AMP} ) > {V}_{MAX} \qquad ( 9 )$$

Equation (8) indicates that if the product of the peak amplitude from the original input audio signal and the constant gain of the amplifier circuitry 204 is less than or equal to the maximum voltage determined by the max identifier circuitry 504, then there is no need for attenuation from the equalizer circuitry 202 because the output audio signal V_{PEAK}(G_{AMP}) does not lead to the membrane exceeding the maximum excursion value. Accordingly, the gain determiner circuitry 506 sets G_{EQ}=1 in such examples.

In contrast, equation (9) indicates that if the product of the peak amplitude from the original input audio signal and the constant gain of the amplifier circuitry 204 is greater than the maximum voltage determined by the max identifier circuitry 504, then there is a need for attenuation from the equalizer circuitry 202 because the voltage V_{PEAK}(G_{AMP}) would lead to the membrane exceeding the maximum excursion value. Therefore, the gain determiner circuitry 506 sets G_{EQ}=(V_{MAX}/G_{AMP}) at corresponding frequency, thereby lowering the output voltage applied to the low-power speaker device 110B to V_{MAX}.

The coefficient generator circuitry 508 determines the equalization coefficients to control the equalizer circuitry 202 to apply the various G_{EQ} values across frequencies within the audio signal. The techniques used to find the equalization coefficients may be responsive to the structural topology used to implement the equalizer circuitry 202.

FIG. 6 is a block diagram of an example of the equalizer circuitry 202 of FIG. 2. The equalizer circuitry 202 includes example Nonlinear Compensation (NLC) circuitry 602, example bass enhancement circuitry 604, and example bass equalization coefficients (606).

The NLC circuitry 602 includes a first input that receives an unadjusted copy of the input audio signal from the software application 114. The NLC circuitry 602 also includes a second input coupled to the coefficient calculator circuitry 220, and an output. Using the equalization coefficients provided at the second input, the NLC circuitry 602 applies one of the various G_{EQ} values responsive to the substantially real time frequency of the audio signal. As a result, the NLC circuitry 602 performs the real-time attenuation necessary to account for the nonlinearities around F₀ and keep the membrane from vibrating past the maximum excursion value.

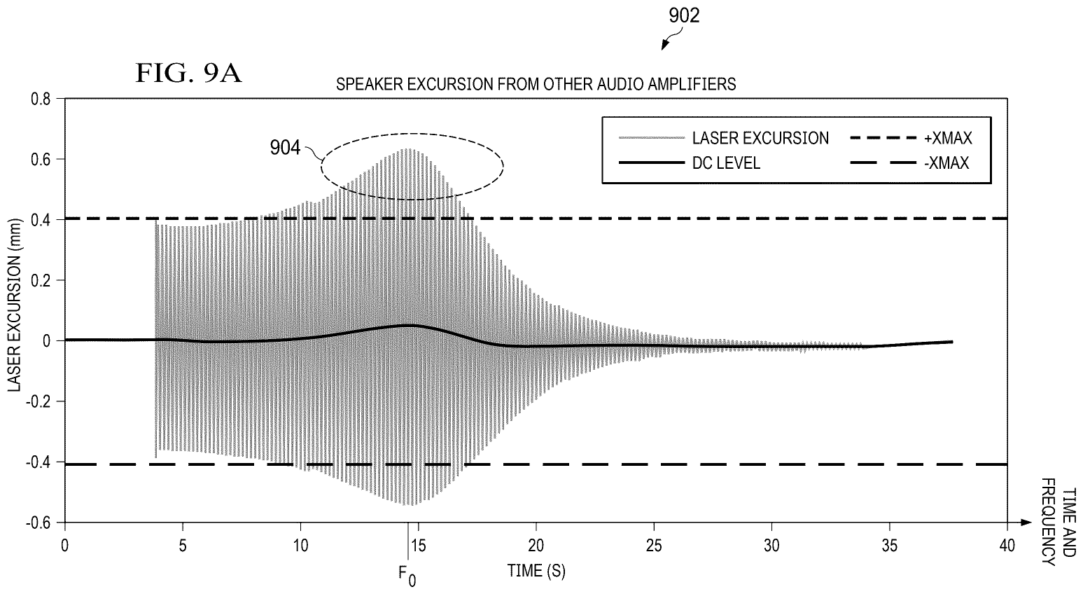

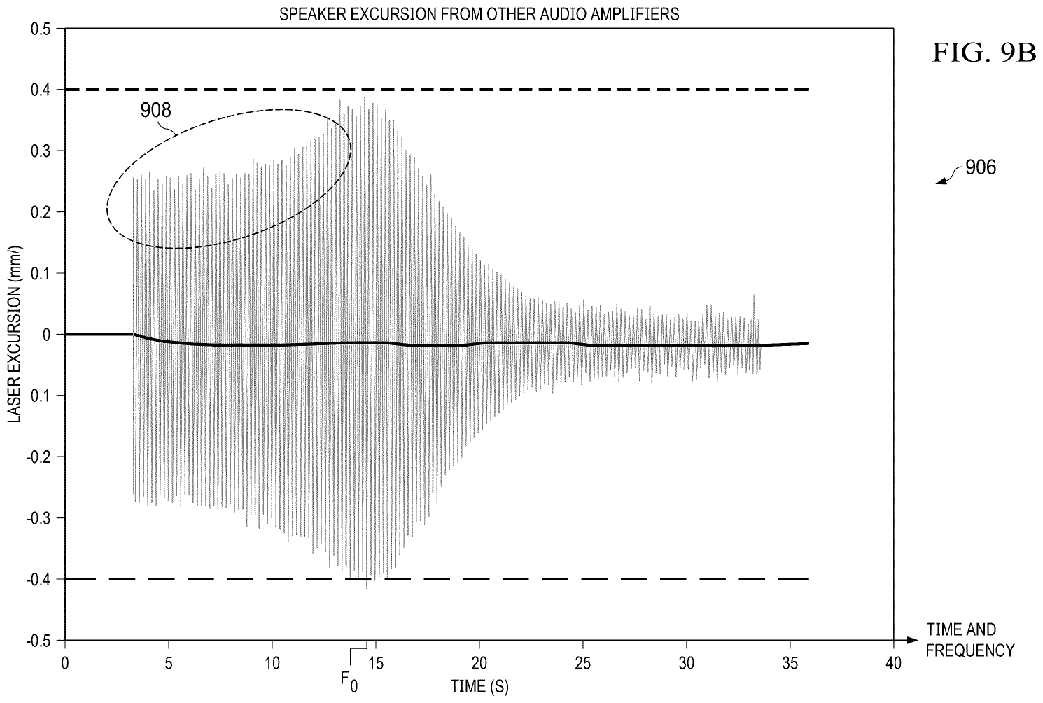

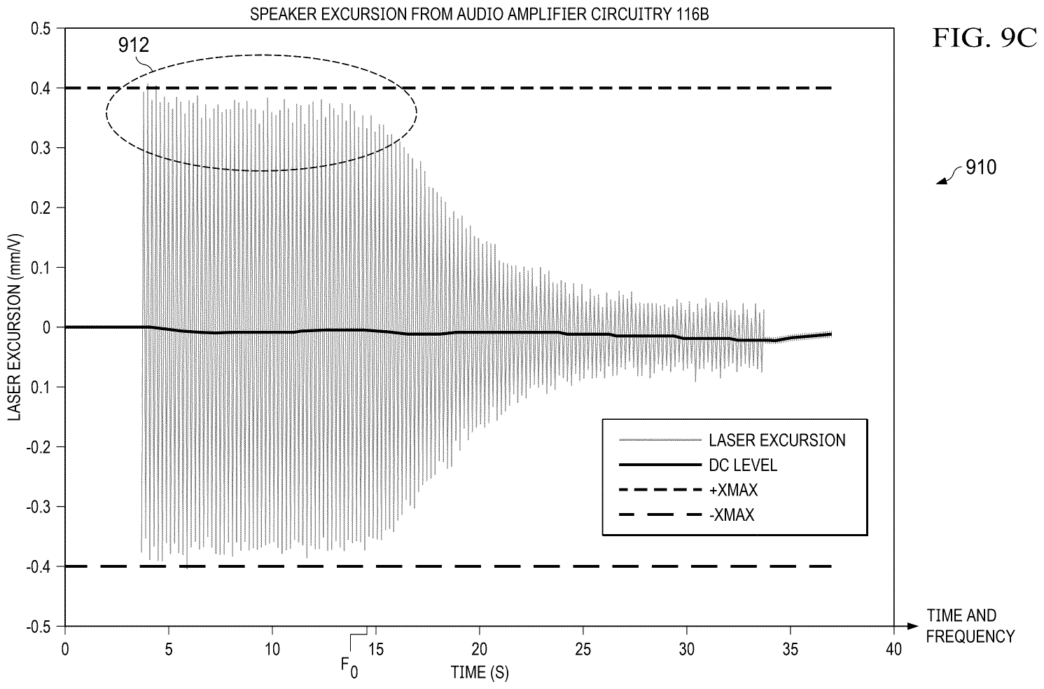

In some examples, the software application 114 attempts to keep the membrane from vibrating past the maximum excursion value by scaling the amplitude of the audio signal down across all frequencies. In such examples, the scaling down may successfully prevent the speaker membrane from vibrating past the maximum excursion value at frequencies around F₀. However, such operations also scale down bass frequencies to amplitudes that are significantly below the maximum excursion value, thereby lowering audio quality when the low-power speaker device 110B plays the bass frequencies. The foregoing scale down operations are described further in connection with FIG. 9B.

The NLC circuitry 602 alters the shape of the audio signal by decreasing the signal amplitude at frequencies around F₀. Accordingly, in some examples, the output of the NLC circuitry 602 still includes the unneeded signal attenuation in bass frequencies as described above. To correct this, the output of the NLC circuitry 602 is coupled to a first input of the bass enhancement circuitry 604. The bass enhancement circuitry 604 also includes a second input that receives bass equalization coefficients 606 and an output coupled to the amplifier circuitry 204.

The bass enhancement circuitry 604 corrects for the unneeded bass attenuation by using the bass equalization coefficients 606 to increase the amplitude of bass frequencies closer to V_{MAX}. As a result, the final audio signal provided to the low-power speaker device 110B prevents the membrane from vibrating past the maximum excursion value at all frequencies, and also improves the audio quality of the signal in bass frequencies.

In some examples, the output of the coefficient calculator circuitry 220 is referred to as first equalization coefficients, and the bass equalization coefficients 606 are referred to as second equalization coefficients. In some examples, the bass equalization coefficients 606 are programmed into the equalizer circuitry 202 during manufacture of the mobile device 102B.

FIG. 7 is a flowchart representative of example machine-readable instructions or example operations 700 that may be at least one of executed, instantiated, or performed by one or more components in the audio amplifier circuitry 116B, including programmable circuitry, to adjust an audio signal. The machine-readable instructions or operations 700 begin when the F₀ tracker circuitry 216 determines the resonant frequency (F₀) of the speaker. (Block 702). In examples described above and herein, the speaker of block 702 is the low-power speaker device 110B. The F₀ tracker circuitry 216 determines F₀ by comparing the current impedance of the low-power speaker device 110B to a general impedance form as described above in connection with FIG. 3. The F₀ tracker circuitry 216 determines the current impedance value using V_{SENSE}(s) data and I_{SENSE}(s) data produced by the measurement circuitry 206, ADC circuitry 208, and the ADC circuitry 210.

The filter applier circuitry 406 within the filter bank circuitry 218 applies a band pass filter centered at F₀ to an audio signal. (Block 704). The audio signal of block 704 refers to the unadjusted input audio signal provided by the software application 114. As described further in connection with FIG. 3, the multiplexer 404 determines which filter is used at block 704 by selecting one of the BPFs 402 responsive to the F₀ value provided at block 702.

The max identifier circuitry 504 within the coefficient calculator circuitry 220 determines maximum voltages (V_{MAX}) for the filtered portions of the audio signal. (Block 706).

As used above and herein, the filtered portion of the audio signal refers to the output of the band pass filter applied at block 704 (e.g., portions of the signal having frequencies near F₀). To determine V_{MAX}, the max identifier circuitry 504 applies the nonlinear model 108 to the current frequency of the audio signal to determine what voltage, when applied to the low-power speaker device 110B at the current frequency, controls the membrane of the speaker to vibrate at the maximum excursion value.

The gain determiner circuitry 506 determines whether a peak voltage (V_{PEAK}) in the filtered portion of the audio signal is greater in magnitude than the V_{MAX} value at the corresponding frequency. (Block 708). The corresponding frequency of block 708 refers to the frequency at which the peak detector circuitry 502 identified V_{PEAK}. Therefore, the frequency of block 708 may be any frequency remaining after application of the bandpass filter.

If the magnitude of V_{PEAK} is greater than V_{MAX} at the corresponding frequency (Block 708: Yes), the audio signal requires attenuation at the corresponding frequency. Accordingly, in such examples, the gain determiner circuitry 506 sets the equalizer gain (G_{EQ}) equal to (V_{MAX}/G_{AMP}) as described above in equation (9). (Block 710).

Alternatively, if the magnitude of V_{PEAK} is less than or equal to V_{MAX} at the corresponding frequency (Block 708: No), the audio signal does not require attenuation at the corresponding frequency. Accordingly, in such examples, the gain determiner circuitry 506 sets the equalizer gain (G_{EQ}) equal to 1 as described above in equation (8). (Block 712).

The coefficient generator circuitry 508 generates first equalization coefficient values that implements the G_{EQ} values from blocks 710 and 712. (Block 714). The NLC circuitry 602 within the equalizer circuitry 202 then attenuates the filtered portion of the audio signal using the first equalization coefficients. (Block 716). To do so, the NLC circuitry 602 receives an unadjusted version of the audio signal from the software application 114, identifies which portions of the signal require attenuation responsive to the first equalization coefficients, and reduces the magnitude of the signal accordingly. The NLC circuitry 602 only identifies frequencies near F₀ for attenuation at block 716 because the first equalization coefficients are determined responsive to the band pass filter applied at block 704.

The bass enhancement circuitry 604 within the equalizer circuitry 202 increases the amplitude of the bass frequencies in the audio signal using second equalizer coefficients. (Block 718). The second equalizer coefficients of block 718 refer to the bass equalization coefficients 606 of FIG. 6. After increasing the bass, the bass enhancement circuitry 604 provides the audio to the amplifier circuitry 204, which applies a gain G_{AMP} evenly across all frequencies and provides the resulting signal to the low-power speaker device 110B.

The audio amplifier circuitry 116B determines whether to continue performing equalization operations. (Block 720). The audio amplifier circuitry 116B performs equalization operations whenever the software application 114 provides an audio signal. The software application 114 may stop providing an audio signal at any time and for any reason (e.g., a song ends). If the audio amplifier circuitry 116B continues performing equalization operations (Block 720: Yes), control returns to block 702 where the F₀ tracker circuitry 216 updates the current F₀ value of the low-power speaker device 110B. Alternatively, the machine-readable instructions or operations 700 end if the audio amplifier circuitry 116B continues performing equalization operations (Block 720: No).

The example flowchart of FIG. 7 presents the machine-readable instructions or operations 700 as a set of serial operations, blocks 702-718, that loop back and repeat at block 720. In other examples, the machine-readable instructions or operations 700 continually executes one of more of blocks 702-718 to implement a pipeline of operations. Collectively, the machine-readable instructions or operations 700 prevents the membrane from vibrating past the maximum excursion value at all frequencies and also improves the audio quality of the signal in bass frequencies.

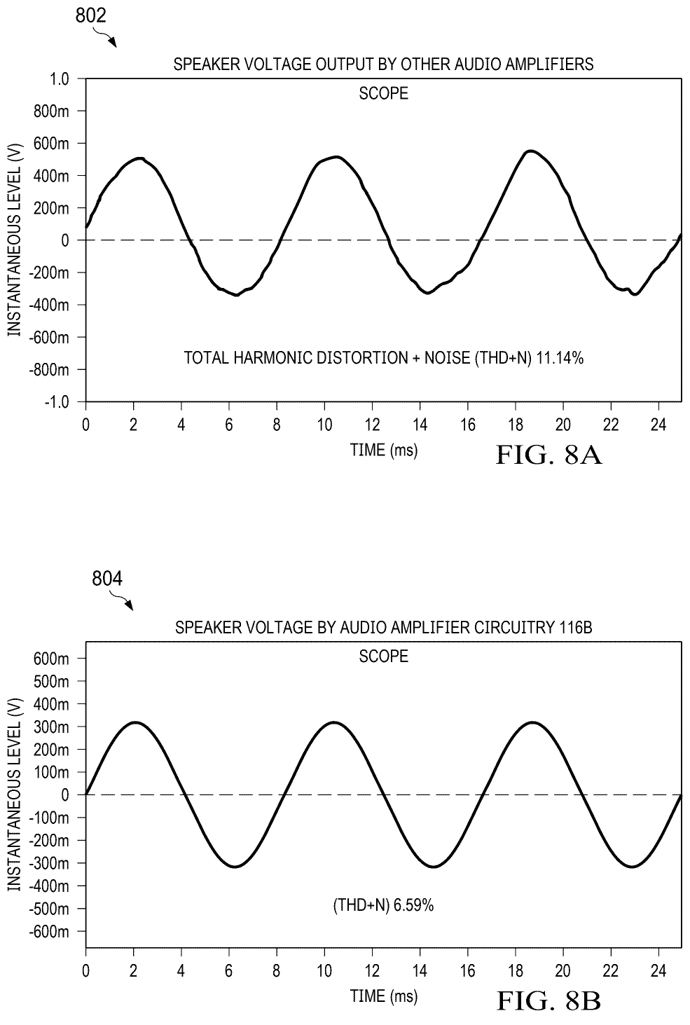

FIGS. 8A and 8B are first example graphs comparing the performance of the audio amplifier circuitry of FIG. 1 to other audio amplifiers. FIG. 8A shows an example graph 802 that represents the speaker voltage provided by audio amplifier circuit that does not track F₀ or implement the nonlinear model 108. The graph 802 shows that, because the circuit adjusts audio signals without considering the nonlinear behavior of the speaker devices, the speaker voltage has a comparatively large amount of Total Harmonic Distortion and Noise (THD+N) at 11.14%. The graph 802 also shows that the THD+N also leads to visual distortions to the speaker voltage (e.g., at local maximums and minimums of the signal) that correspond to a decrease in audio quality.

In contrast, FIG. 8B shows an example graph 804 that represents the speaker voltage provided by the audio amplifier circuitry 116B described in the examples herein. The audio amplifier circuitry 116B does account for nonlinearities of the low-power speaker device 110B by tracking changes to F₀, using the nonlinear model 108 to attenuate frequencies around the current value of F₀, and boosting bass frequencies. As a result, the audio amplifier circuitry 116B has a comparatively low THD+N at 6.60% when processing the same audio signal provided to the other amplifier circuit of FIG. 8A. The graph 804 also has fewer visual distortions to the speaker voltage than the graph 802.

FIGS. 9A, 9B, and 9C are second example graphs comparing the performance of the audio amplifier circuitry of FIG. 1 to other audio amplifiers. FIGS. 9A-9C includes example graphs 902, 906, 910, and example regions 904, 908, and 912. Each of the graphs represent the performance of a low-power speaker device that has a maximum excursion value of 0.4 millimeters (mm). Accordingly, the speaker device is designed to vibrate around 0 mm and operates safely whenever the membrane is between [−0.4 mm, +0.4 mm]. If the membrane of the speaker moves outside of the foregoing excursion range, DC offset accumulates and the speaker can become damaged.

The graphs 902, 906, and 910 represent three tests of the three different amplifier circuits using the same input conditions. In the tests, the input of the amplifier circuits is a chirp signal that increases in frequency over time from 100 Hz to 300 kHz. Thus, the x axis of the graphs 902, 906, and 910 represent both time and frequency. The graphs display speaker excursion in mm on the y axis.

FIG. 9A represents the speaker excursion from a first audio amplifier circuit that does not track F₀ or implement the nonlinear model 108. Graph 902 shows that the first audio amplifier circuit is unable to keep the speaker excursion within the range [−0.4 mm, +0.4 mm] at any frequency, and that extreme failure occurs in the region 904 (e.g., at F₀ and its surrounding frequencies). As a result, DC offset accumulates and a speaker coupled to the first audio amplifier circuit can become damaged.

FIG. 9B represents the speaker excursion from a second audio amplifier circuit that does not track F₀ or implement the nonlinear model 108. Graph 902 shows that the second audio amplifier circuit scales the magnitude of the audio signal down across all frequencies, thereby keeping the speaker excursion within the range [−0.4 mm, +0.4 mm]. However, the second audio amplifier circuit suffers from poor audio quality because the bass frequencies in the region 908 are significantly below the maximum excursion value.

FIG. 9C represents the speaker excursion from the audio amplifier circuitry 116B, which does track F₀ and does implement the nonlinear model 108. As a result, the graph 910 and the region 912 show the membrane of the low-power speaker device 110B vibrates close to but under 0.4 mm during both bass frequencies and frequencies near F₀. Thus, the audio amplifier circuitry 116B breaks the trade-off between bass performance and DC offset shown in FIGS. 9A and 9B.

FIG. 10 is a block diagram of an example of the modeling circuitry 106 of FIG. 1. FIG. 10 shows the mobile device 102A the modeling circuitry 106 and the nonlinear model 108. The modeling circuitry 106 includes example control circuitry 1004, example speaker measurement circuitry 1006, and example nonlinear analysis circuitry 1008.

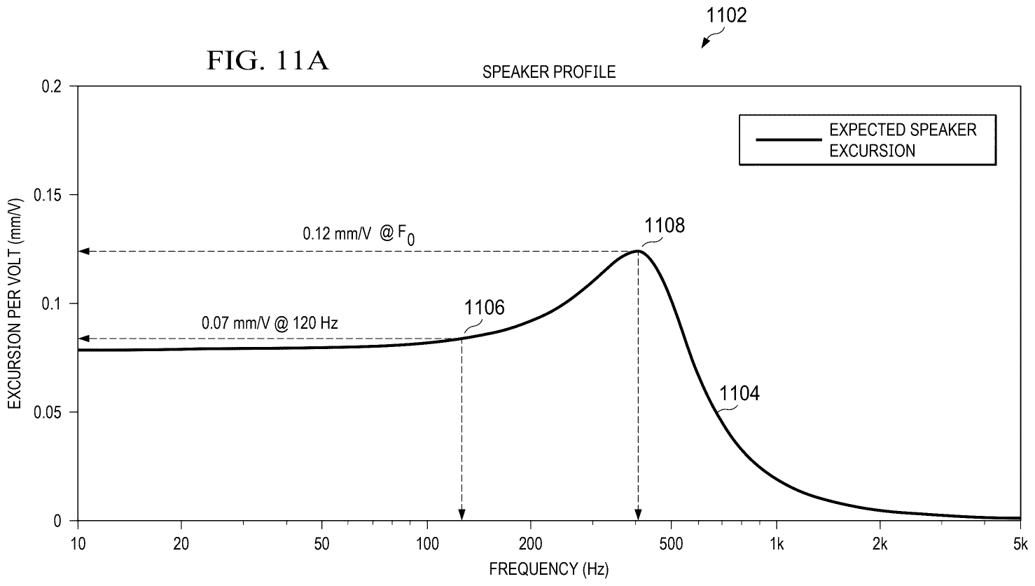

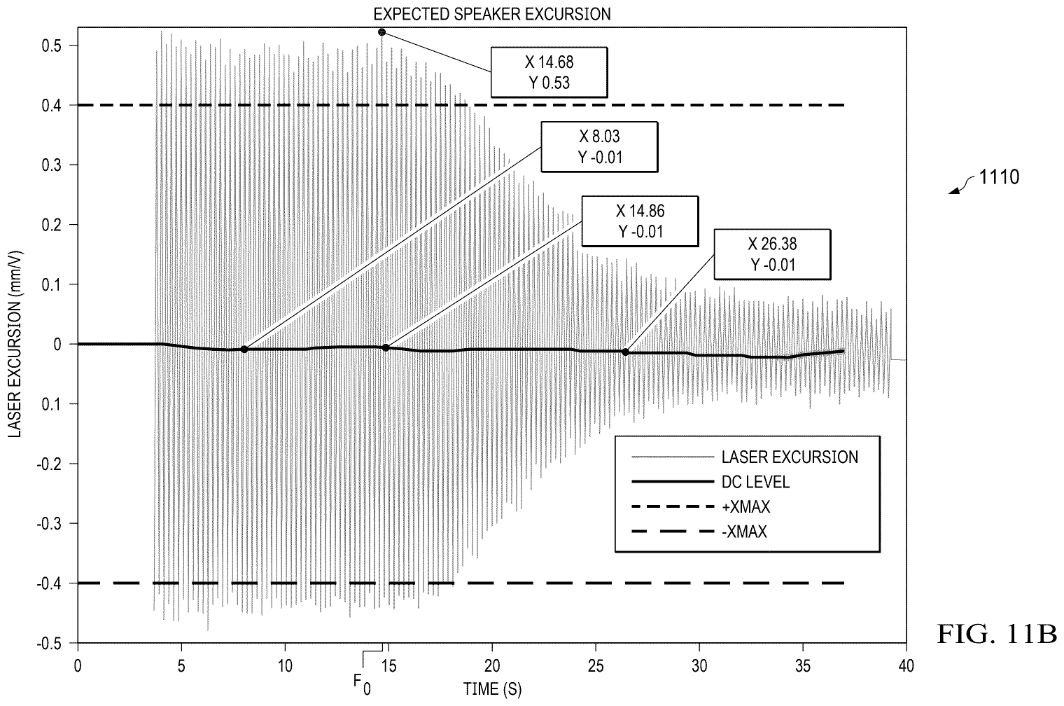

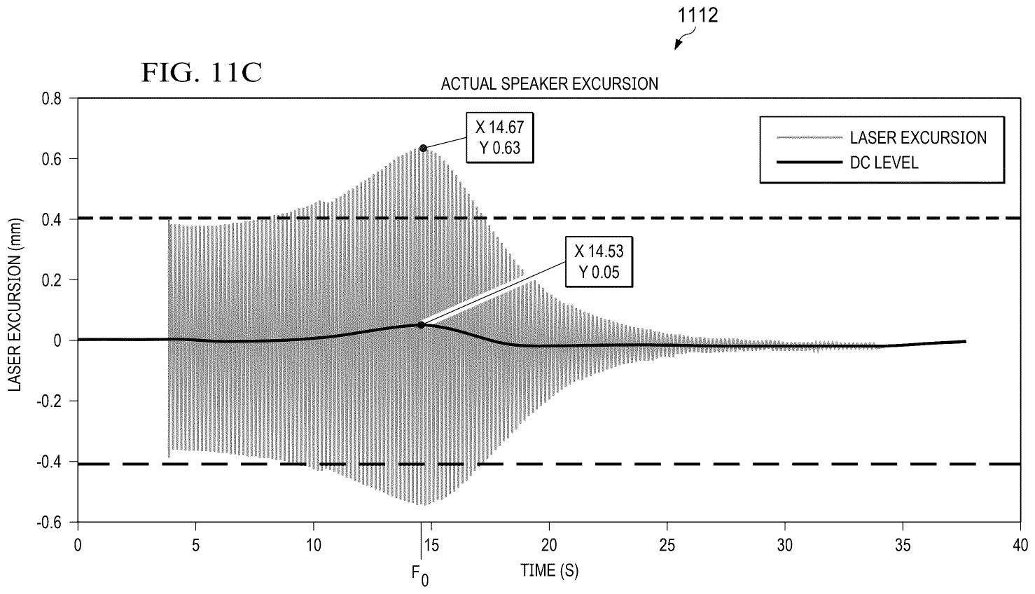

The control circuitry 1004 uses the mobile device 102A to generate a nonlinear model 108. The control circuitry 1004 may be implemented by any type of programmable circuitry. Within the control circuitry 1004, the speaker measurement circuitry 1006 measures the actual speaker excursion of the mobile device 102A. To do so, the speaker measurement circuitry 1006 first sends a control signal to the mobile device 102A. The control signal instructs the mobile device 102A to play test audio, which vibrates the membrane of the low-power speaker device 110A. The speaker measurement circuitry 1006 measures the amount that the membrane moves to receive actual speaker excursion data. Actual speaker excursion data is described further in connection with FIG. 11C.

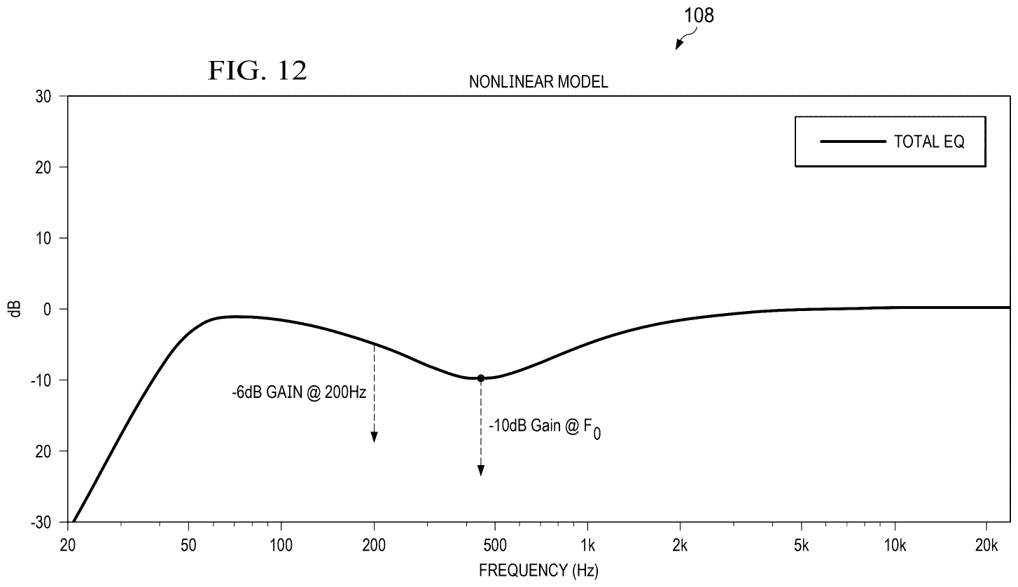

In the example of FIG. 10, the speaker measurement circuitry 1006 uses a laser to measure the membrane vibration. In other examples, the speaker measurement circuitry 1006 uses other techniques to measure membrane vibration. Such techniques include but are not limited to positioning a microphone next to the low-power speaker device 110A, capacitive sensing, etc. The nonlinear analysis circuitry 1008 then uses the actual speaker excursion data to create the nonlinear model 108 as described further in connection with FIGS. 11C and 12.

FIG. 11A is an example graph illustrating a speaker profile data of the mobile device 102A of FIG. 1. The example graph 1102 includes an example speaker profile 1104 and example data points 1106 and 1108. The graph 1102 displays frequency in Hertz on the x axis. The graph also displays excursion per Volts, measured in mm/V, on the y axis.

The graph 1102 shows the excursion per Volts of the low-power speaker device 110A changes as a function of frequency. For example, at the data point 1106, the speaker profile 1104 indicates that the membrane moves approximately 0.07 mm responsive to application of one Volt at 120 Hz to the low-power speaker device 110A. At the data point 1108, the speaker profile 1104 indicates that the membrane moves approximately 0.12 mm responsive to the application of one Volt at F₀ (which equals 420 Hz in the example of FIG. 11A). The speaker profile 1104 also indicates that membrane excursion increases linearly as voltage increases. Thus, in some examples, the speaker profile 1104 is referred to as a linear model of the low-power speaker devices 110.

The speaker profile 1104 can be used to determine expected voltages at different frequencies that lead to the membrane moving the maximum excursion value at the frequencies. For example, using 0.4 mm as the maximum excursion value results in equations (10)-(12):

$$\frac{0.4 mm}{0.12 mm / {V}_{{F}_{0}}} = 3.33 {V}_{{F}_{0}} expected voltage for max excursion at {F}_{0} \qquad ( 10 )$$

$$\frac{0.4 mm}{0.07 mm / {V}_{120}} = 5.7 {V}_{120} expected voltage for max excursion at 120 Hz \qquad ( 11 )$$

$$4.46 {V}_{{F}_{0}} ( 0.12 \frac{mm}{{V}_{{F}_{0}}} ) = 0.53 mm expected excursion at 4.46 {V}_{{F}_{0}} \qquad ( 12 )$$

As used above and herein, Vₓ refers to the voltage applied to the low-power speaker device 110A at x Hz.

FIGS. 11B and 11C include example graphs 1110 and 1112. Each of the graphs represent the performance of a low-power speaker device that has a maximum excursion value of 0.4 millimeters (mm). Accordingly, the speaker device is designed to vibrate around 0 mm and operates safely whenever the membrane is between [−0.4 mm, +0.4 mm]. If the membrane of the speaker moves outside of the foregoing excursion range, DC offset accumulates and the speaker can become damaged.

The graphs 1110 and 1112 represent two tests in which the input of the amplifier circuits is a chirp signal that increases in frequency over time from 100 Hz to 300 kHz. Thus, the x axis of the graphs 1110 and 1112 represent both time and frequency. The graphs display speaker excursion in mm on the y axis.

FIG. 11B shows an expected amount of speaker excursion that occurs responsive to the speaker profile 1104. Notably, the expected speaker excursion of FIG. 11B is approximately equal (at around 0.53 mm as expressed in equation (12)) between 0 Hz and F₀. The graph of FIG. 11B therefore implies an audio amplifier circuit using only the speaker profile 1104 can generate high quality audio if the appropriate voltage is applied (e.g., if graph 1110 is scaled down equally across all frequencies).

FIG. 11C shows the output of the speaker measurement circuitry 1006. Because the same chirp signal is provided to the low-power speaker device 110B to produce both graphs 1110 and 1112, FIGS. 11B and 11C would match if the speaker profile 1104 was accurate. However, there are differences in the shapes of the graphs 1110 and 1112 because of nonlinearities of the low-power speaker devices 110. For example, applying 4.46 V at F₀ results in a membrane excursion of 0.63 mm rather than the 0.53 mm expected at equation (12). More generally, FIGS. 11B and 11C show excess membrane movement at all frequencies, and particularly around the resonant frequency, responsive to nonlinearities. If left unmitigated, the nonlinearities result in DC offset that damages the low-power speaker devices 110.

FIG. 12 is an example graph showing the nonlinear model 108 of FIG. 1. FIG. 12 shows the nonlinear model 108 includes data points that correlate frequency (displayed on the x axis in Hertz) to a desired amount of attenuation (displayed on the y axis in decibels (dB) on the y axis).

The nonlinear analysis circuitry 1008 generates the data points by comparing the expected speaker excursion to the actual speaker excursion. For example, as described above in equation (10), the expected speaker excursion data indicates that 3.33 V at F₀ causes the membrane to reach the maximum excursion value of 0.4 mm. However, the nonlinear analysis circuitry 1008 evaluates equations (13) and (14) to determined that only ˜2.8 at F₀ causes the membrane to reach the maximum excursion value:

$$\frac{0.63 mm actual excursion at {F}_{0}}{4.46 {V}_{{F}_{0}}} = 0.14 \frac{m m}{{V}_{{F}_{0}}} \qquad ( 13 )$$

$$\frac{0.4 mm}{0.14 mm / {V}_{{F}_{0}}} = 2.8 {V}_{{F}_{0}} ( actual voltage that reaches maximum excursion ) \qquad ( 14 )$$

The nonlinear analysis circuitry 1008 includes a data point <F₀, −10 dB> to describe 2.8 V_{F}_{₀}, the actual maximum voltage (as opposed to the expected maximum voltage of 3.3 V described above) that can be applied at F₀ without damaging the membrane. In the example of FIG. 12, the gain of the amplifier circuitry 204 is 8.92. Thus, the nonlinear analysis circuitry 1008 evaluates equations (15) and (16) to determine the value-10 dB:

$$\frac{{V}_{{F}_{0}} actual}{{G}_{A}} = \frac{2.8 V}{8.92} = 0.31 V \qquad ( 15 )$$

$$- 20 {log}_{10} ( 0.31 V ) \approx - 10 dB \qquad ( 16 )$$

The nonlinear analysis circuitry 1008 performs a similar analysis across the range of possible input frequencies to populate the nonlinear model 108. Accordingly, a given data point in the nonlinear model 108 describes how much attenuation at a given frequency keeps the membrane of the speaker at or beneath the maximum excursion value. In general, FIG. 12 shows that attenuation grows to its largest value at F₀ (e.g., F₀ has the lowest y value), and that little to no attenuation is required (e.g., the y value is at or near 0 dB) at frequencies farther away from F₀. One exception to this characterization is between 20 Hz to 60 Hz, where the attenuation increases from approximately −30 dB to approximately 0 dB because speaker devices exhibit nonlinear behavior both at F₀ and in bass frequencies.

Notably, the nonlinear model 108 allows the audio amplifier circuitry 116B to preserve the shape of the incoming audio signal as measured in volts and change the shape of the incoming signal as measured in speaker excursion. For example, suppose the audio signal generated by the software application 114 ranges between [2.0 V and 4.0 V] when at F₀. In such examples, the audio amplifier circuitry 116B uses the value of 10 dB in the nonlinear model 108 to scale all voltages at F₀ down by a factor of approximately 1.43, thereby making the output voltage at F₀ range between [1.4 V, 2.8 V] and keeping all membrane vibration at F₀ at or under the maximum excursion value. Suppose further that the audio signal generated by the software application 114 also ranges between [2.0 V and 4.0 V] when at 200 Hz. The audio amplifier circuitry 116B scales all voltages at F₀ down by a factor less than 1.43 because −6 Hz >−10 Hz, meaning the audio signal requires less attenuation at 200 Hz than at F₀ to stay at or under the maximum excursion value.

FIG. 13 is a flowchart representative of example machine-readable instructions or example operations that may be at least one of executed, instantiated, or performed using an example programmable circuitry implementation of the modeling circuitry of FIG. 1. FIG. 13 The machine-readable instructions or operations 1300 begin when the speaker measurement circuitry 1006 measures actual speaker excursion data. (Block 1302). The actual speaker excursion data records how much the membrane of the low-power speaker device moves in response to a voltage applied at a given frequency. The speaker measurement circuitry 1006 may apply use any suitable technique to measure membrane movement, including but not limited to lasers, microphones, cameras, capacitive sensing, etc.

The nonlinear analysis circuitry 1008 calculates max voltages based on the actual speaker excursion. (Block 1304). For example, the nonlinear analysis circuitry 1008 may execute versions of equations (13) and (14) described above across a range of gain values and a range of frequencies.

The nonlinear analysis circuitry 1008 determines a nonlinear model responsive to the max voltages. (Block 1306). Determining nonlinear excursion data includes but is not limited to executing versions of equations (15) and (16) described above for the respective max voltages. More generally, the nonlinear model 108 includes dB values that describe what voltage is required at different frequencies of an incoming audio signal to keep the membrane of the low-power speaker devices 110 at or below the maximum excursion value. For example, the nonlinear model 108 enables the audio amplifier circuitry 116B to adjust an input audio signal by converting: an input voltage from the input audio signal to a maximum voltage from block 1304 that is lower than the input voltage. Notably, the membrane vibration of the low-power speaker device 110B exceeds the maximum excursion value if the input voltage is applied at a particular frequency. However, membrane vibration of the low-power speaker device 110B does not exceed the maximum excursion value if the maximum voltage at block 1304 is applied to the same frequency. In some examples, the nonlinear model 108 is referred to as a large signal model because it improves performance for signals with comparatively large amplitudes (e.g., high volumes). The nonlinear model 108 also improves performance around F₀ and in bass frequencies as described above. The machine-readable instructions or operations 1300 end after block 1306.

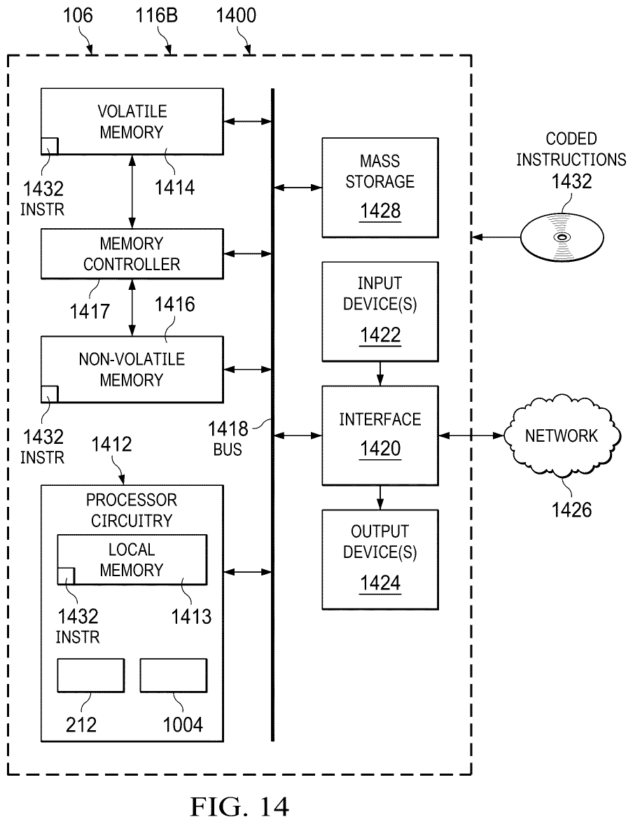

FIG. 14 is a block diagram of an example programmable circuitry platform 1400 structured to one or a combination of execute or instantiate one or more of the example machine-readable instructions or the example operations of FIGS. 7 and 13 to implement the modeling circuitry 106 or audio amplifier circuitry 116B of FIG. 2 or 10. The programmable circuitry platform 1400 can be, for example, a server, a personal computer, a workstation, a self-learning machine (e.g., a neural network), a mobile device (e.g., a cell phone, a smart phone, a tablet such as an iPad™), an Internet appliance, etc. or other wearable device, or any other type of computing or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, or microcontrollers from any desired family or manufacturer. The programmable circuitry 1412 may be implemented by one or more semiconductor based (e.g., silicon based) devices. In this example, the programmable circuitry 1412 implements the control circuitry 212 or the control circuitry 1004.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1416 may be implemented by one or a combination of flash memory or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter one of or a combination of data or commands into the programmable circuitry 1412. The input device(s) 1422 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1424 are also connected to the interface circuitry 1420 of the illustrated example. The output device(s) 1424 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1420 of the illustrated example, thus, includes one of or a combination of a graphics driver card, a graphics driver chip, or graphics processor circuitry such as a GPU.

The interface circuitry 1420 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store one or more of firmware, software, or data. Examples of such mass storage discs or devices 1428 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1432, which may be implemented by the machine-readable instructions of FIGS. 7 and 13, may be stored in one of or a combination of the mass storage device 1428, in the volatile memory 1414, in the non-volatile memory 1416, or on at least one non-transitory computer readable storage medium such as a CD or DVD which may be removable.

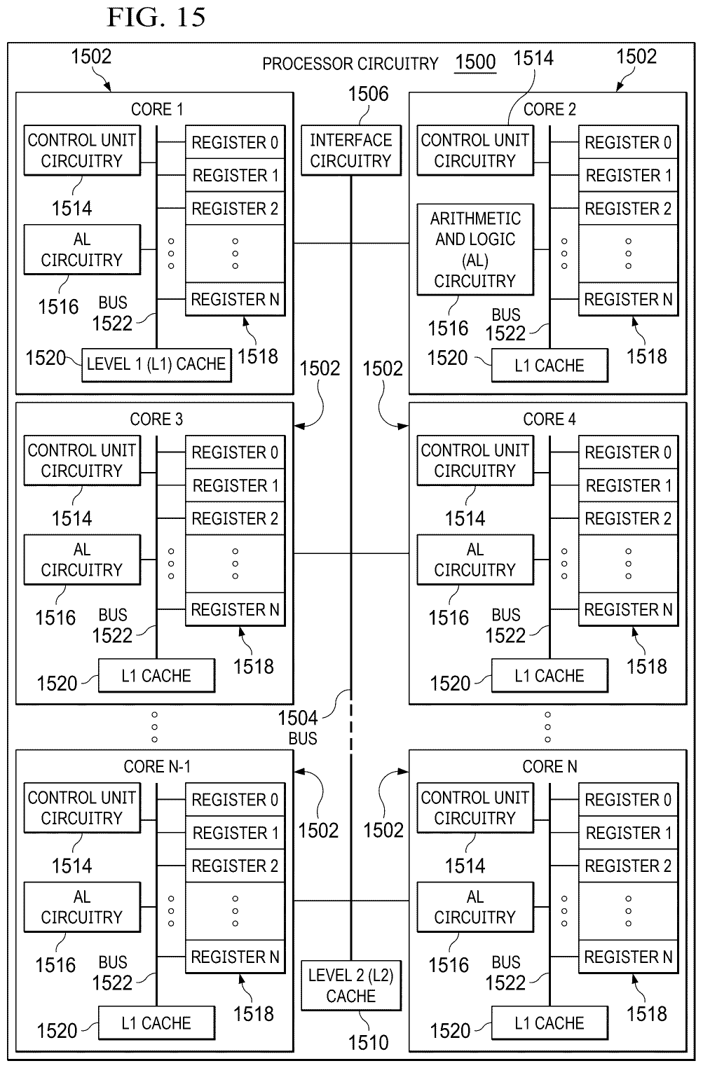

FIG. 15 is a block diagram of an example of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 7 and 13 to effectively instantiate the circuitry of FIG. 2 as logic circuits to perform operations corresponding to those machine-readable instructions. In some such examples, the circuitry of FIG. 2 or 10 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions or operations represented by the flowcharts of FIGS. 7 and 13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Also or alternatively, the first bus 1504 may be implemented by any other type of computing or electrical bus. The cores 1502 may receive data, instructions, and signals from one or more external devices by example interface circuitry 1506. The cores 1502 may output data, instructions, and signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and instructions. Data and instructions may be transferred (e.g., shared) by one of or a combination of writing to or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Generally, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 or, more generally, the microprocessor 1500 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1500 is a semiconductor device fabricated to include many transistors interconnected to implement the structures described above in one or more integrated circuits (ICs) contained in one or more packages.

The microprocessor 1500 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those described herein. A GPU, DSP, or other programmable device can also be an accelerator. Accelerators may be on-board the microprocessor 1500, in the same chip package as the microprocessor 1500, or in one or more separate packages from the microprocessor 1500.

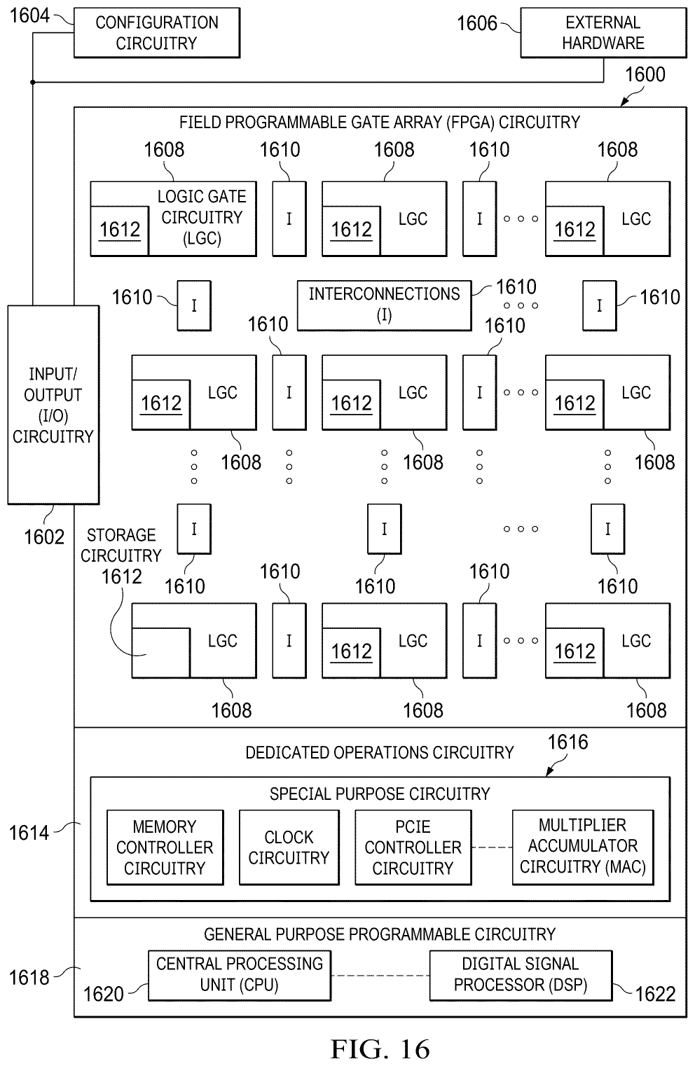

FIG. 16 is a block diagram of another example of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 7 and 13 but whose interconnections and logic circuitry are fixed once fabricated), the FPGA circuitry 1600 of the example of FIG. 16 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 7 and 13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software or firmware) represented by the flowchart(s) of FIGS. 7 and 13. As such, the FPGA circuitry 1600 may be at least one of configured or structured to effectively instantiate some or all of the operations/functions corresponding to the machine-readable instructions of the flowchart(s) of FIGS. 7 and 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 7 and 13 faster than the general-purpose microprocessor can execute the same.

In the example of FIG. 16, the FPGA circuitry 1600 is at least one of configured or structured in response to being programmed (or reprogrammed one or more times) responsive to a binary file. In some examples, the binary file may be one of or both of compiled or generated responsive to instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may at least one of access or load the binary file to control the FPGA circuitry 1600 of FIG. 16 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1600 of FIG. 16 to at least one of configure or structure the FPGA circuitry 1600 of FIG. 16, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform responsive to the second instructions. In some examples, the FPGA circuitry 1600 of FIG. 16 may at least one of access or load the binary file to control the FPGA circuitry 1600 of FIG. 16 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1600 of FIG. 16 to at least one of configure or structure the FPGA circuitry 1600 of FIG. 16, or portion(s) thereof.

The FPGA circuitry 1600 of FIG. 16, includes example input/output (I/O) circuitry 1602 to at least one of receive or output data to/from at least one of example configuration circuitry 1604 or external hardware 1606. For example, the configuration circuitry 1604 may be implemented by interface circuitry that may receive a binary file, which may be implemented by one or more of a bit stream, data, or machine-readable instructions, to configure the FPGA circuitry 1600, or portion(s) thereof. In some such examples, the configuration circuitry 1604 may receive the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 7 and 13 or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of one of or a combination of the electrical structures or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 or an example DSP 1622. Other general purpose programmable circuitry 1618 may also or alternatively be present such as a GPU, an XPU, etc., that can be programmed to perform other operations.

Although FIGS. 15 and 16 illustrate two examples of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may also be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 7 and 13 to perform first operation(s)/function(s), the FPGA circuitry 1600 of FIG. 16 may be at least one of configured or structured to perform second operation(s)/function(s) corresponding to a second portion of the machine-readable instructions represented by the flowcharts of FIGS. 7 and 13, or an ASIC may be at least one of configured or structured to perform third operation(s)/function(s) corresponding to a third portion of the machine-readable instructions represented by the flowcharts of FIGS. 7 and 13.

Some or all of the circuitry of FIG. 2 or 10 may, thus, be instantiated at the same or different times. For example, same or different portion(s) of the microprocessor 1500 of FIG. 15 may be programmed to execute portion(s) of machine-readable instructions at the same or different times. In some examples, same or different portion(s) of the FPGA circuitry 1600 of FIG. 16 may be at least one of configured or structured to perform operations/functions corresponding to portion(s) of machine-readable instructions at the same or different times.

In some examples, some or all of the circuitry of FIG. 2 or 10 may be instantiated, for example, in one or more threads executing concurrently or in series. For example, the microprocessor 1500 of FIG. 15 may execute machine-readable instructions in one or more threads executing concurrently or in series. In some examples, the FPGA circuitry 1600 of FIG. 16 may be at least one of configured or structured to carry out operations/functions concurrently or in series. Moreover, in some examples, some or all of the circuitry of FIG. 2 or 10 may be implemented within one or more virtual machines or containers executing on the microprocessor 1500 of FIG. 15.

In some examples, the programmable circuitry 1412 of FIG. 14 may be in one or more packages. For example, at least one of the microprocessor 1500 of FIG. 15 or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

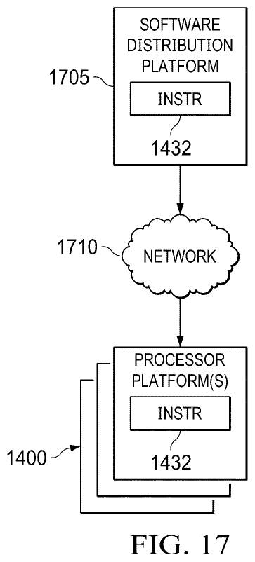

A block diagram illustrating an example software distribution platform 1705 to distribute software such as the example machine-readable instructions 1432 of FIG. 14 to other hardware devices (e.g., one or more hardware devices owned or operated by third parties from the owner or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity at least one of owning or operating the software distribution platform 1705. For example, the entity that at least one of owns or operates the software distribution platform 1705 may be at least one of a developer, a seller, or a licensor of software such as the example machine-readable instructions 1432 of FIG. 14. The third parties may be consumers, users, retailers, OEMs, etc., who one of or a combination of purchase or license the software for at least one of use, re-sale, or sub-licensing. In the illustrated example, the software distribution platform 1705 includes one or more servers and one or more storage devices. The storage devices store the machine-readable instructions 1432, which may correspond to the example machine-readable instructions of FIGS. 7 and 13, as described above. The one or more servers of the example software distribution platform 1705 are in communication with an example network 1710, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third-party payment entity. The servers enable one or more purchasers or licensors to download the machine-readable instructions 1432 from the software distribution platform 1705. For example, the software, which may correspond to the example machine-readable instructions of FIGS. 7 and 13, may be downloaded to the example programmable circuitry platform 1400, which is to execute the machine-readable instructions 1432 to implement the modeling circuitry 106 or audio amplifier circuitry 116B. In some examples, one or more servers of the software distribution platform 1705 periodically at least one of offer, transmit, or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

Flowchart(s) representative of example machine-readable instructions, which may be executed by programmable circuitry to at least one of implement or instantiate the modeling circuitry 106 or audio amplifier circuitry 116B of FIG. 2 or 10 or representative of example operations which may be performed by programmable circuitry to at least one of implement or instantiate the modeling circuitry 106 or audio amplifier circuitry 116B of FIG. 2 or 10, are shown in FIGS. 7 and 13. The machine-readable instructions may be one or more executable programs or portion(s) of one or more executable programs for execution by programmable circuitry such as the programmable circuitry 1412 shown in the example programmable circuitry platform 1400 described below in connection with FIG. 14 and may be one or more function(s) or portion(s) of functions to be performed by the example programmable circuitry (e.g., an FPGA) described below in connection with FIG. 15 or 16. In some examples, the machine-readable instructions lead to an operation, a task, etc., to be carried out or performed in an automated manner in the real-world. As used herein, “automated” means without human involvement.

The program may be embodied in instructions (e.g., software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7 and 13, many other methods of implementing the example modeling circuitry 106 or audio amplifier circuitry 116B may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks, or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., for them to be directly readable, interpretable, or executable by a computing device or other machine. For example, the machine-readable instructions may be stored in multiple parts, which are individually compressed, encrypted, or stored on separate computing devices, such that the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7 and 13 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, whereas the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. Although certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Modifications are possible in the described embodiments, and other embodiments are possible, within the scope of the claims.

From the foregoing, it is appreciated that example systems, apparatus, articles of manufacture, and methods have been described that reduce nonlinear behavior in low-power speaker devices. Described systems, apparatus, articles of manufacture, and methods improve the efficiency of using a computing device by tracking F₀ of the low-power speaker device in substantially real time, using the current F₀ value and a nonlinear model to determine voltages at different frequencies that keep the speaker at or under a maximum excursion value, and determining equalization coefficients that shape an audio signal to implement the foregoing voltages, and applying other equalization coefficients to implement bass frequency improvements. Described systems, apparatus, articles of manufacture, and methods are also directed to one or more improvement(s) in the operation of a machine such as a computer or other electronic, electromechanical, or mechanical device.

What is claimed is:

1. An apparatus comprising:
equalizer circuitry having first and second inputs and an output, the equalizer circuitry configured to adjust an audio signal at the first input responsive to coefficient values at the second input;
amplifier circuitry having an input coupled to the output of the equalizer circuitry, and having an output; and
control circuitry having a first input coupled to the first input of the equalizer circuitry, having a second input coupled to the output of the amplifier circuitry, and having an output coupled to the second input of the equalizer circuitry, the control circuitry configured to determine a resonant frequency of a speaker device responsive to the audio signal and a signal at the output of the amplifier circuitry, and to provide the coefficient values at the output of the control circuitry responsive to the resonant frequency of the speaker device.

2. The apparatus of claim 1, further including measurement circuitry having an input coupled to the output of the amplifier circuitry, the measurement circuitry configured to determine a voltage and a current of an output audio signal.

3. The apparatus of claim 2, wherein the control circuitry is configured to determine the resonant frequency responsive to the current and the voltage of the output audio signal.

4. The apparatus of claim 1, wherein the equalizer circuitry includes:
first equalizer circuitry having a first input coupled to the control circuitry, a second input, and an output, the first equalizer circuitry configured to receive the audio signal at the second input; and
second equalizer circuitry having an input coupled to the output of the first equalizer circuitry and an output coupled to the amplifier circuitry.

5. The apparatus of claim 4, wherein:
the coefficient values are first coefficients;
the first equalizer circuitry is configured to adjust the audio signal using the first coefficients to mitigate speaker device nonlinearity; and
the second equalizer circuitry is configured increase an amplitude of bass frequencies within the audio signal using second coefficients.

6. An apparatus comprising:
control circuitry configured to:
determine a speaker device resonant frequency; and
determine coefficient values responsive to the speaker device resonant frequency and a speaker device nonlinear model;
equalizer circuitry coupled to the control circuitry and configured to provide an adjusted audio signal using the coefficient values; and
amplifier circuitry coupled to the equalizer circuitry and configured to amplify the adjusted audio signal to provide an output audio signal.

7. The apparatus of claim 6, wherein to determine the speaker device resonant frequency, the control circuitry is configured to:
determine an impedance value based on the output signal;
compare the impedance value to a template impedance form; and
determine the speaker device resonant frequency responsive to the comparison.

8. The apparatus of claim 6, wherein the control circuitry is configured to:
generate a plurality of bandpass filters that are centered at different frequencies;
select, from bandpass filters that are centered at different frequencies, a bandpass filter that is centered at the determined speaker device resonant frequency; and
apply the bandpass filter to the audio signal to generate a filtered audio signal.

9. The apparatus of claim 8, wherein the control circuitry is configured to:
determine, using the nonlinear model, a first voltage of the filtered audio signal at the determined speaker device resonant frequency; and
determine, using the nonlinear model, a second voltage of the filtered audio signal at a bass frequency that is less than the determined speaker device resonant frequency.

10. The apparatus of claim 9, wherein the control circuitry is configured to:
detect a peak in the filtered audio signal; and
set, using the peak and the first voltage, a gain value of the filtered audio signal at the determined speaker device resonant frequency.

11. The apparatus of claim 10, wherein:
the control circuitry is configured to provide coefficients to the equalizer circuitry responsive to the gain value; and
the amplifier circuitry is configured to produce the output audio signal by multiplying, at the resonant frequency, the adjusted audio signal and the gain value.

12. The apparatus of claim 10, wherein the control circuitry is configured to set the gain value to one responsive to an amplitude of the peak being less than the first voltage.

13. The apparatus of claim 10, wherein the control circuitry is configured to set the gain value responsive to a combination of the first voltage and a gain of the amplifier circuitry responsive to a determination that an amplitude of the peak being greater than the first voltage.

14. The apparatus of claim 9, wherein the control circuitry is configured to:
detect a peak in the filtered audio signal; and
set a gain value of the filtered audio signal at the bass frequency, using the peak and the second voltage.

15. Control circuitry configured to:
measure membrane excursion values of a speaker device at different frequencies to determine a maximum excursion value;
determine maximum voltages that correspond to the maximum excursion value at different frequencies; and
determine, responsive to the maximum voltages, a nonlinear model corresponding to the speaker device.

16. The control circuitry of claim 15, wherein:
a first maximum voltage within the maximum voltages corresponds to a first frequency; and
the speaker device is configured to vibrate a membrane at the maximum excursion value in response to receiving the first maximum voltage at the first frequency.

17. The control circuitry of claim 16, wherein:
the control circuitry is first control circuitry configured to provide the nonlinear model to second control circuitry; and
the second control circuitry is configured to adjust an audio signal corresponding to the speaker device using the nonlinear model.

18. The control circuitry of claim 17, wherein to adjust the audio signal, the second control circuitry is configured to convert an input voltage that corresponds to the first frequency into the first maximum voltage, the conversion performed responsive to the nonlinear model, the input voltage responsive to a linear model of the speaker device.

19. The control circuitry of claim 16, further configured to determine the nonlinear model responsive to a combination of the maximum voltages and gain values of the speaker device that correspond to the different frequencies.

20. The control circuitry of claim 19, further configured to measure the membrane excursion values using a laser.
